(19) United States
(12) Patent Application Publication
(10) Pub. No.: US 2008/0114493 A1
(43) Pub. Date: May 15, 2008

(54) Motion control data transmission and motion playing method for audio device-compatible robot terminal

(75) Inventor: Kyoung Jin Kim, Seoul (KR)

Correspondence Address: BIRCH STEWART KOLASCH & BIRCH, PO BOX 747, FALLS CHURCH, VA, 22040-0747, US

(73) Assignee: iO.TEK Co., Ltd

(21) Appl. No.: 11/725,505

(22) Filed: Mar. 20, 2007

(30) Foreign Application Priority Data
Nov. 15, 2006 (KR) 10-2006-112660

(51) Int. Cl. G05B 19/04

(52) U.S. Cl. 700/249

(57) ABSTRACT

Disclosed herein is a motion control data transmission and motion playing method for an audio device-compatible robot terminal.

The method, comprising the steps of:
creating a multimedia file, including motion control data, in an audio transmission file format in such a manner that motion control data and data for determination of whether the motion control data is included are inserted into a specific channel and audio data is inserted into another specific channel; sending the multimedia file, including the motion control data, to a terminal device using a transmission method suitable for the audio transmission file format; the terminal device determining whether the motion control data is included based on the determination data included in the multimedia file, including the motion control data, and sending the motion control data to the robot terminal if the motion control data is included, and sending no motion control data if the motion control data is not included; the robot terminal sending the received motion control data to a motion driving device; and playing motion of the robot terminal through the motion driving device.

### BACKGROUND OF THE INVENTION

1. Field of the Invention

The present invention relates to a motion control data transmission and motion playing method for an audio device-compatible robot terminal that is capable of playing multimedia content files that include motion control information.

2. Description of the Related Art

In the future, various types of home robots will spread to almost every household, and various functions will be performed using such home robots. One representative field of application thereof is an education field that utilizes the playing of audio and video content (hereinafter referred to as “multimedia content”) for the narration of fairy tales, English education, etc.

In a prior art home robot system, when a user connects to a service server via a home robot or a Personal Computer (PC) and obtains a specific narrated fairy tale or English learning content from a homepage free of charge or on payment of a fee, a text/audio file and video file for the content, stored in the service server, are downloaded to and stored in a home robot, and the home robot plays the narrated fairy tale or English learning content by playing the video file while issuing utterance using an audio file, resulting from conversion of a sentence through a Text-To-Speech (TTS) engine, or using a transmitted audio file at the time desired by the user. As a result, in order to play a large amount of downloaded audio and video data, the processor, memory and Hard Disk Drive (HDD) of the robot are required to have capacity almost the same as in the case of a PC, so that the cost of the home robot is high.

Furthermore, at the time of playing such a narrated fairy tale and English learning audio and video, the home robot just plays audio and video, but does not perform motion related to the audio and the video (for example, a robot's bowing motion or a robot's lip motion (which is synchronized with the utterance of a sentence) that Is performed when the sentence “How are you?” or “Hello”)), so that the interest of infants or children cannot be aroused using the narrated fairy tale or English learning content.

As a result, in the prior art home robot system, the home robot requires a high-capacity central processing unit and high-capacity memory so as to use audio and video content, and interest is not stimulated because there is no motion corresponding to audio and video.

In order to overcome the problems of the prior art, the preceding U.S. Ser. No. 11/327,403 of the present applicant proposes a scheme in which, as shown in FIG. 1, only a transmission/reception device 5-1, 5-2, . . . , or 5-N for transmitting and receiving data to and from a server 7, a sensor 4-1, 4-2, . . . , or 4-N such as a microphone, a motor/relay 2-1, 2-2, . . . , or 2-N, a motor/relay driving circuit 3-1, 3-2, . . . , or 3-N, a D/A converter 6-1, 6-2, . . . , or 6-N, a speaker 10-1, 10-2, . . . , or 10-N and/or a video display control device and a monitor are installed in each of the robot terminals 1-1, 1-2, . . . , and 1-N, and a large amount of data processing for creating motion data for the robot terminals 1-1, 1-2, . . . , and 1-N and for creating audio files and/or video files are performed in the service server 7. Accordingly, the robot terminals 1-1, 1-2, . . . , and 1-N do not require high-capacity central processing devices and high-capacity memory, so that it is possible to provide inexpensive home robots.

Furthermore, in order to perform motion synchronized with audio and/or video, the prior art proposes a method of sending and receiving data between the service server 7 and the robot terminals 1 in such a way as to divide audio/video/motion data at the intervals Ts of the playing of audio/video/motion data and forms audio/video/motion data into a single packet at each interval of playing.

However, in order to transmit and receive data between the service server 7 and the robot terminals 1 in such a packet transmission fashion according to the prior art of the present applicant, a special data format for transmitting audio/video/motion data using a single packet must be created, specific software (including a transmission error recovery function) and hardware for interpreting the data format in both systems at the time of performing transmission and reception using the data format are required. That is, in order to use the prior art transmission method of the present applicant, dedicated transmission/reception and interpretation software and hardware are required, therefore massive time, manpower and cost are required to build the prior art data transmission and reception systems.

### SUMMARY OF THE INVENTION

Accordingly, the present invention has been made keeping in mind the above problems occurring in the prior art, and an object of the present invention is to provide a motion control data transmission and motion playing method for an audio device-compatible robot terminal system, in which WAVE files, which are widely used by PCs for transmitting music files, are adopted, a PC receives multimedia data including motion control information for a robot terminal, and an audio device-compatible robot terminal connected to the PC plays the multimedia data including the motion information.

In order to accomplish the above object, the present invention provides a motion control data transmission and motion playing method for an audio device-compatible robot terminal, comprising the steps of:

creating a multimedia file, including motion control data, in an audio transmission file format in such a manner that motion control data and data for determination of whether the motion control data is included are inserted into a specific channel and audio data is inserted into another specific channel; sending the multimedia file, including the motion control data, to a terminal device using a transmission method suitable for the audio transmission file format; the terminal device determining whether the motion control data is included based on the determination data included in the multimedia file, including the motion control data, and sending the motion control data to the robot terminal if the motion control data is included, and sending no motion control data if the motion control data is not included; the robot terminal sending the received motion control data to a motion driving device; and playing motion of the robot terminal through the motion driving device.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the prior art, a patent for which has been applied for by the present applicant;

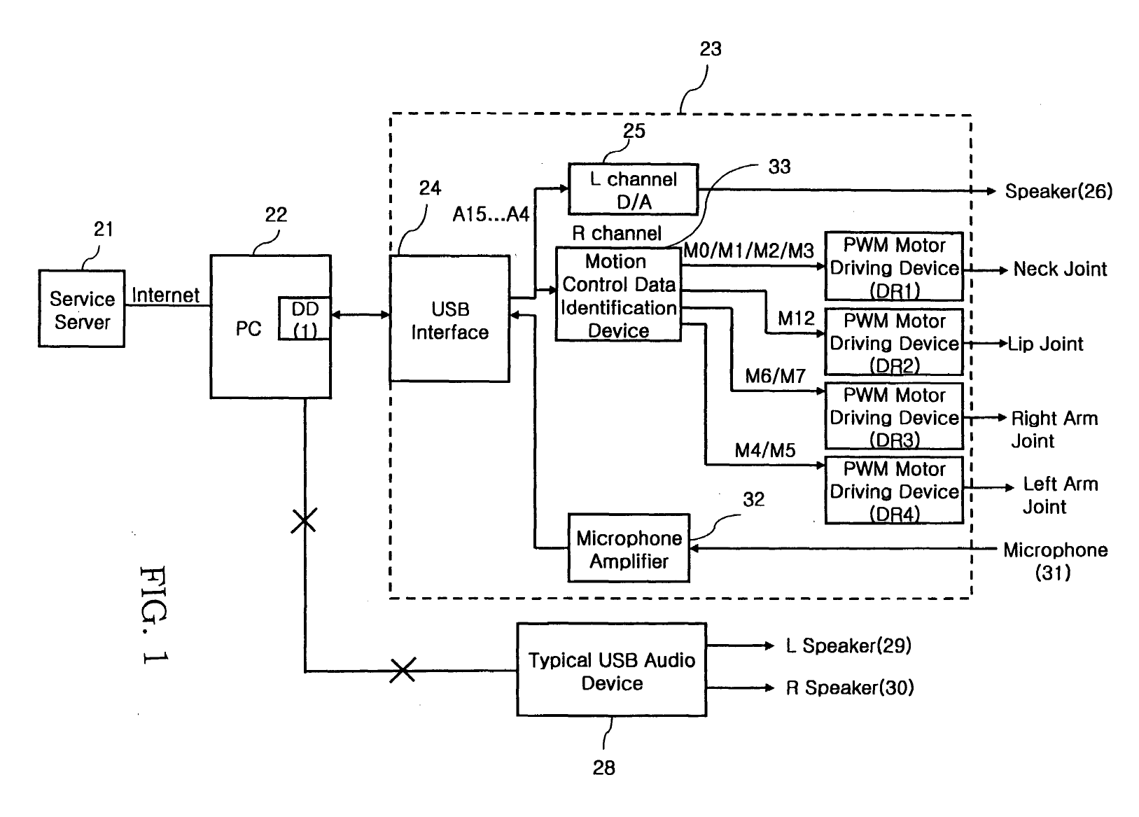

FIG. 2 is a diagram showing a method by which audio data is stored in a WAVE file;

FIG. 3 is a diagram showing prior art using a typical USB audio device;

FIG. 4 is a diagram showing the audio device-compatible robot terminal of the present invention that is connected to a PC;

FIG. 5 is a diagram showing the construction of the entire system that includes the robot terminal of the present invention (first embodiment);

FIG. 6 is a diagram showing the format of a WAVE file including motion control data that is used for the present invention;

FIG. 7 is a diagram showing the transmission format of a WAVE file including motion control data that is used for the present invention;

FIG. 8 is a diagram showing time-based data and pulse waveforms that are stored in a motion control data register in the present invention;

FIG. 9 is a table showing the assignment of the respective bits of motion control data (first embodiment);

FIG. 10 is a table showing the assignment of the respective bits of motion control data (second embodiment);

FIG. 11 is a table showing the assignment of the respective bits of motion control data (third embodiment); and

FIG. 12 is a diagram showing the construction of the entire system that includes the robot terminal of the present invention (second embodiment).

### DESCRIPTION OF THE PREFERRED EMBODIMENTS

Reference now should be made to the drawings, in which the same reference numerals are used throughout the different drawings to designate the same or similar components.

First, to help understand the present invention, a method of creating a WAVE file for audio data is described in brief below.

A WAVE file format is a file format for storing digital audio (waveform) data. It supports a variety of bit resolutions, sample rates, and the numbers of channels of audio data. A WAVE file includes a format chunk containing information about bit resolution, sampling rate, and the number of channels, and a sound data chunk containing audio data.

Only the method of creating the WAVE file sound data that is stored in the sound data chunk will be described in brief below. For other details, refer to references provided by respective O/S providers, for example, Microsoft in the case of Windows.

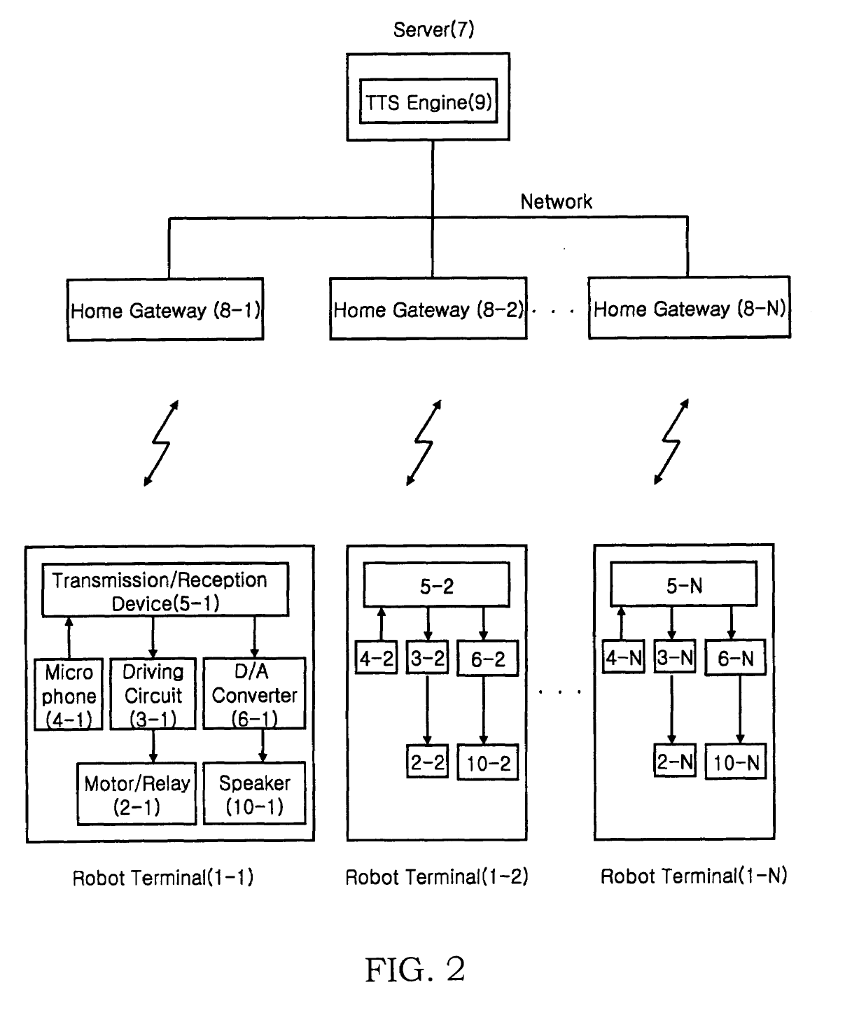

The WAVE file supports multichannel sound, therefore multiple pieces of data, which originate from respective channels and have a single sample time point, are interleaved with each other. For example, in the case of 2-channel stereo sound, pieces of 2-channel sample data (referred to as a “sample frame”) at a specific time point are mixed with each other, and are then stored in the format shown in the first view of FIG. 2. Of course, for mono sound, there is only a single channel, therefore a single sample frame includes one piece of data at each sample time point. A method of storing audio data in the WAVE file format using a multichannel method is summarized as shown in FIG. 2.

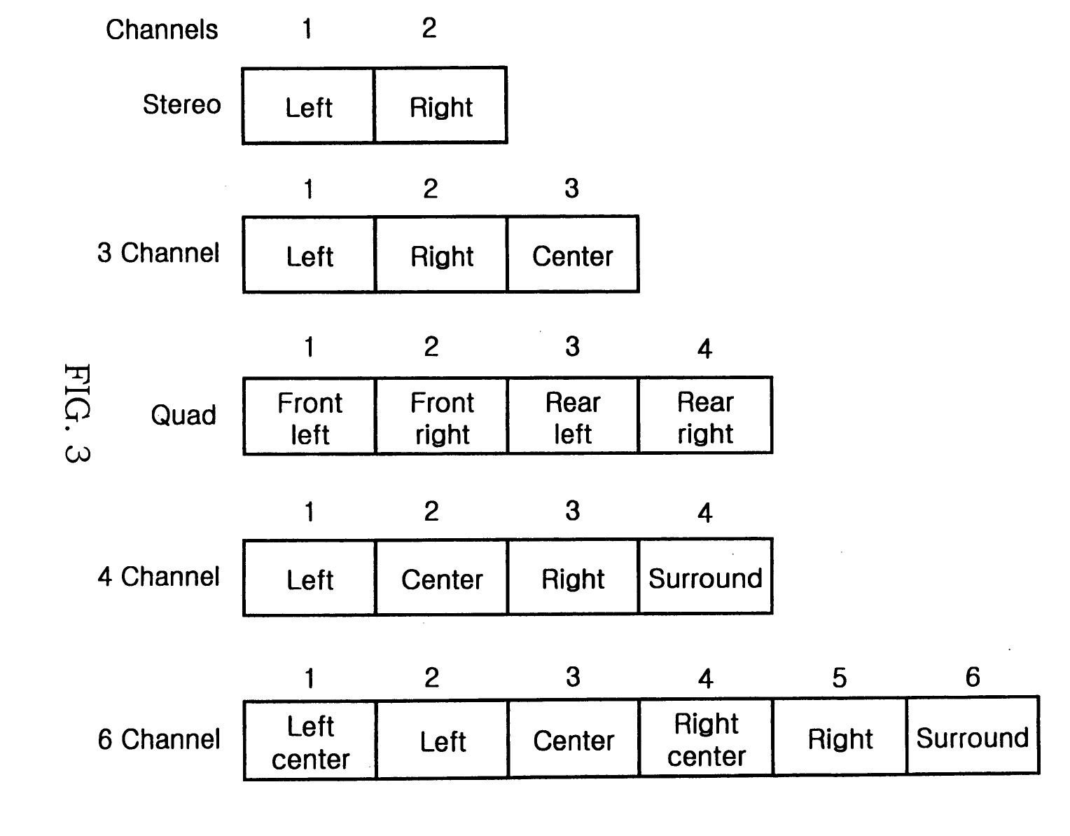

Next, to help understand the structure of the present invention, a method of playing music using a Universal Serial Bus (USB) audio device in an existing PC is described with reference to FIG. 3.

An existing PC 11 uses the WAVE file format to receive a music file. Various O/Ss, for example, Microsoft Windows, support various types of software for sending and playing such WAVE files.

Meanwhile, when a peripheral is connected to a PC 11, a user runs a peripheral setup program and then installs a device driver for the USB audio device 12 in the PC 11, or the O/S of the PC 11 provides such a device driver without requiring a setup program. Accordingly, the PC 11, having received a WAVE file, hands over the received WAVE file to the device driver, and the device driver obtains general digital audio signals, suitable for the USB audio device 12, through a conversion process, and sends the digital audio signals to the USB audio device 12 through a USB port.

Then, a USB interface 13 divides received signals into right and left channel digital audio signals, and send the right and left channel digital audio signals to right and left channel D/A converters 14 and 15, the D/A converters 14 and 15 convert the right and left channel digital audio data into analog audio signals, and then music or voice is issued to the outside through external right and left speakers 16 and 17.

Furthermore, external sound, such as a user's voice, is input to the USB audio device 12 through a microphone 18, and is then input to the PC 11 through a microphone amplifier 19 and a USB interface 13.

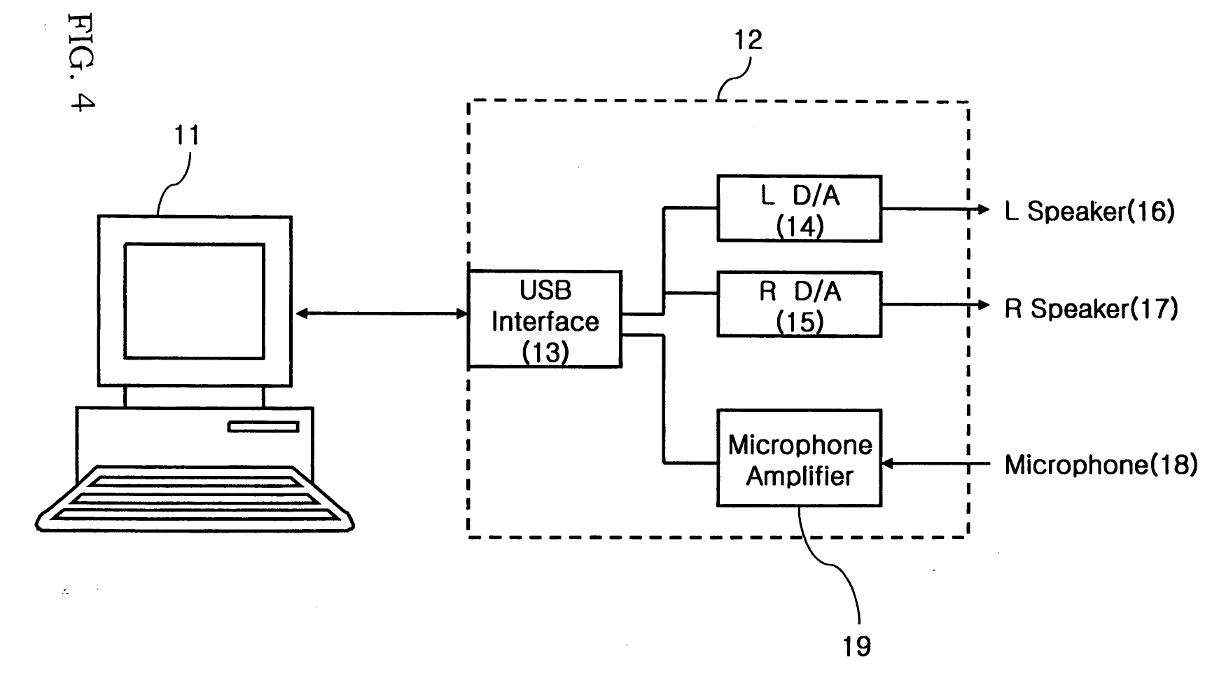

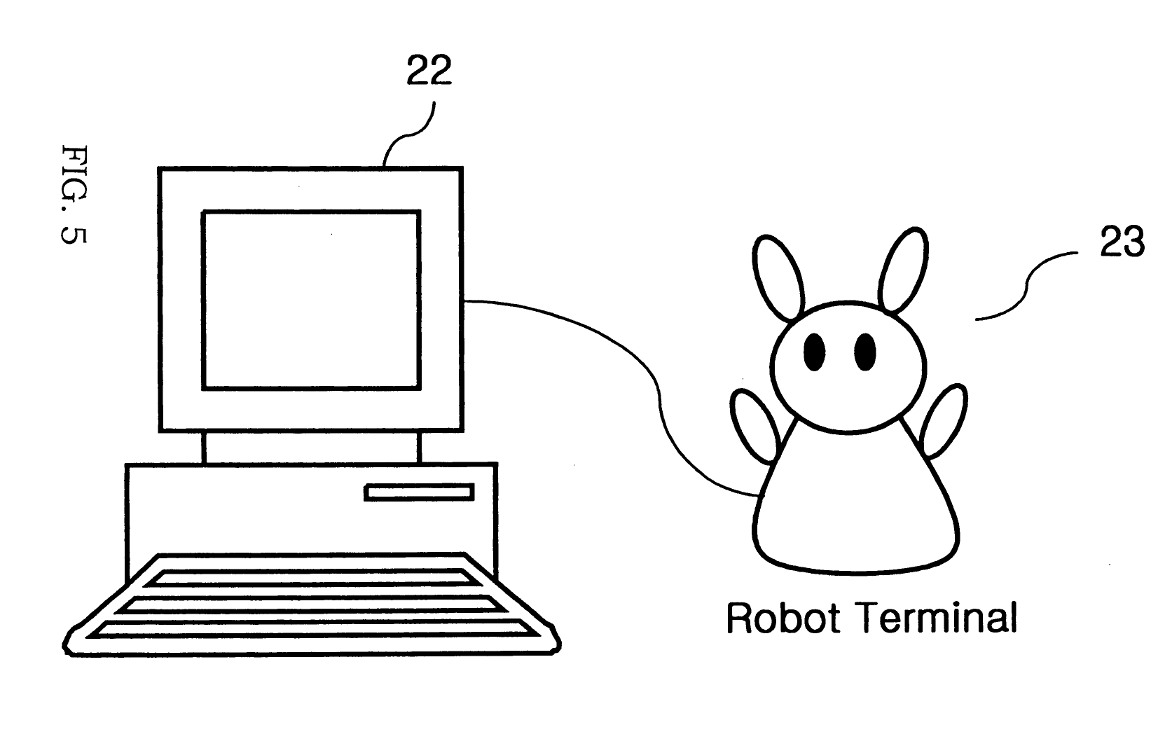

Now, the construction and operation of the USB audio device-compatible robot terminal (hereinafter abbreviated as “robot terminal”) of the present invention, a service server for creating and storing a multimedia content WAVE file that includes motion control data (hereinafter abbreviated as “WAVE file including motion control data”) and sending the WAVE file to the robot terminal, and a PC for receiving the WAVE file including motion control data from the service server and sending the WAVE file to the robot terminal are described in detail with reference to FIGS. 4 and 5 below.

As illustrated in FIG. 4, since the robot terminal 21 of the present invention is identified as a peripheral by the PC 22, like the typical USB audio device 12 shown in FIG. 3, the user runs a setup program and stores a device driver for the robot terminal 23 in the PC 22 at the time of connecting the robot terminal 23 to the PC 22.

The case where, in order to cause the robot terminal 23 to perform related motion while playing a narrated fairy tale, a narrated fairy tale file including motion control data (WAVE file including motion control data) is created and stored in the service server 21, the WAVE file including motion control data is sent to the PC 22 at the request of the PC 22, is converted into data suitable for the specifications of the robot terminal 23 by the robot terminal device driver of the PC 22, and is then sent to the robot terminal 23, and then the robot terminal 23 performs related motion while issuing utterances related to the narrated fairy tale is taken as an example below.

First, a method of creating a WAVE file including motion control data in the service server 11 using a widely used 2-channel (Ch1 and Ch2) audio WAVE file is described below.

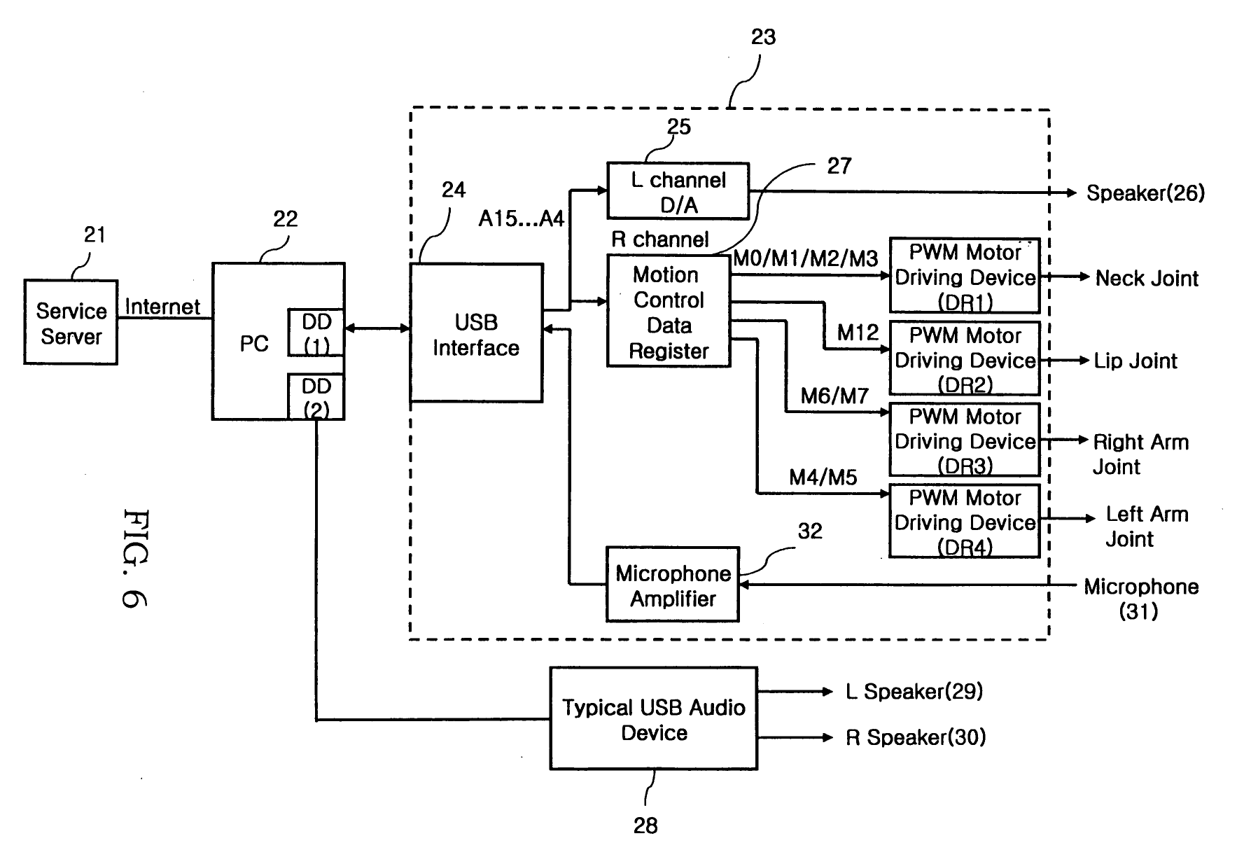

For example, as shown in FIG. 6, audio data A15, . . . , and A0 are assigned to Ch1 so that mono audio having a maximum of 16 bits can be played in consideration of various numbers of audio bits of the robot terminal 23, motion control data M14 . . . , M0 having a maximum of 15 bits are assigned to Ch2 so that the robot terminal 23 forms a maximum of 15 motor driving Pulse Width Modulation (PWM) pulse strings, and the highest bit M16 is used as a determination bit for determining whether the remaining bits M14, . . . , and M0 are audio data or motion control data according to the pulse string pattern (for example, 0111) of the highest bit M15.

The reason why the determination bit is used is that, since a problem is caused in the motion of the robot terminal 23 by the audio data of Ch2 in the case where the robot terminal 23 is operated according to the data of Ch2 and a general audio file is transmitted through Ch2, it is necessary to determine whether the data of Ch2 is audio data or motion control data. Furthermore, a problem in which WAVE data including motion information is played in a general audio device can be prevented.

Thereafter, the service server 21 stores, at the maximum sampling rate, audio data for a narrated fairy tale using 16 bits (A15, . . . , and A0) via Ch1 (for audio data), and motion control data for the narrated fairy tale using 15 bits (M14, . . . , and M0) via Ch2, and a determination bit is stored using the highest bit M15. Then, in the format shown in FIG. 6, a WAVE file including motion control data (precisely, a sound data chunk including motion control data) in a WAVE file data format capable of supporting various specifications (for the number of audio bits, the number of motion bits, and sampling rate) is created via the respective channels Ch1 and Ch2.

Now, when the PC 22 requests a WAVE file, the WAVE file is sent from the service server 21 to the PC 22 through a communication means, such as the wireless Internet or the wired Internet.

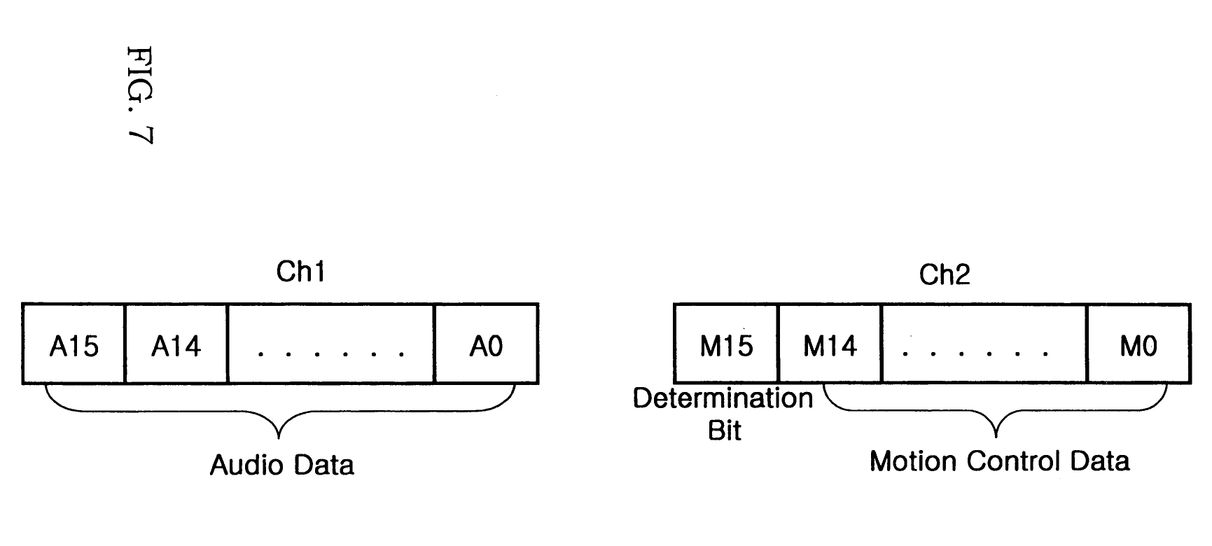

Then, the PC 22 receives the WAVE file including motion control data in the pattern in which Ch1 alternates with Ch2, as illustrated in FIG. 7.

Thereafter, the PC 22 reads 4 pairs of WAVE file data (Ch1(1)/Ch2(1), Ch1(2)/Ch2(2), Ch1(3)/Ch2(3), and Ch1(4)/Ch2(4)), each pair including two 16-bit channels Ch1 and Ch2, and determines whether the four successive M15 bits (M15(1), M15(2), M15(3) and M15(4)) of Ch2 have a bit pattern (for example, “0111”) indicating motion control data by examining the four successive M15 bits (M15(1), M15(2), M15(3) and M15(4)) of Ch2.

If positive, the received file is a WAVE file including motion control data, in which Ch1(1), Ch1(2), Ch1(3) and Ch1(4) are audio data and Ch2(1), Ch2(2), Ch2(3) and Ch2(4) are motion control data, and to which the present invention is applied.

If negative, all of Ch1(1), Ch1(2), Ch1(3), Ch1(4), Ch2(1), Ch2(2), Ch2(3), and Ch2(4) are audio data. Accordingly, using a method of playing audio using the typical USB audio device 28 shown in FIG. 3, the audio data is transferred to a device driver DD2 for a typical USB audio device, so that stereo sound is issued through the right and left speakers 29 and 30 of the typical USB audio device 28.

Meanwhile, if the transmitted data has the bit pattern, 4 pairs of WAVE file data Ch1(1)/Ch2(1), Ch1(2)/Ch2(2), Ch1(3)/Ch2(3), and Ch1(4)/Ch2(4) are handed over to a device driver DD1 for the robot terminal 13.

Then, the driver DD1 selects (samples) Ch 1 audio data A15, . . . , and A0 and motion control data M15, . . . , and M0 in consideration of sampling rate in conformity with the specification of the connected robot terminal 23, and sends it to the robot terminal 23.

In the above case, since the above-described determination bit pattern “0111” exists, four pairs of data are selected (sampled) at one time in the case where the selection of data is performed in consideration of sampling. If the sampling rate of the robot terminal 23 is always the same, the problem of selection (sampling) is automatically solved when mono audio data and motion control data are created at the same sampling rate at the time of creating a WAVE file in the service server 21, and all of the audio data and motion control data of the created WAVE file are transferred to the robot terminal 23 without change.

Since, in the robot terminal 23, 16-bit data received at an odd sequential position corresponds to Ch1 and is mono audio data, only an appropriate number of bits are input to a left channel A/D converter 25 in consideration of the number of bits of the left channel A/D converter 25. For example, when the left channel A/D converter 25 is a 12-bit converter, only the upper 12 bits A15, . . . , and A4 of received mono audio data A15, . . . , and A0 are applied to the input terminal of the left channel A/D converter 25, as shown in FIG. 5, and a narrated fairy tale is issued through the speaker 26.

Meanwhile, since 16-bit data received at an even sequential position by the robot terminal 23 corresponds to Ch2 and is motion control data, motion control data M14, and M0 including a motion determination bit M15 is stored as the respective bits R15, . . . , and R0 of a motion control data register 27 when the 16-bit data is sent to the motion control data register 27.

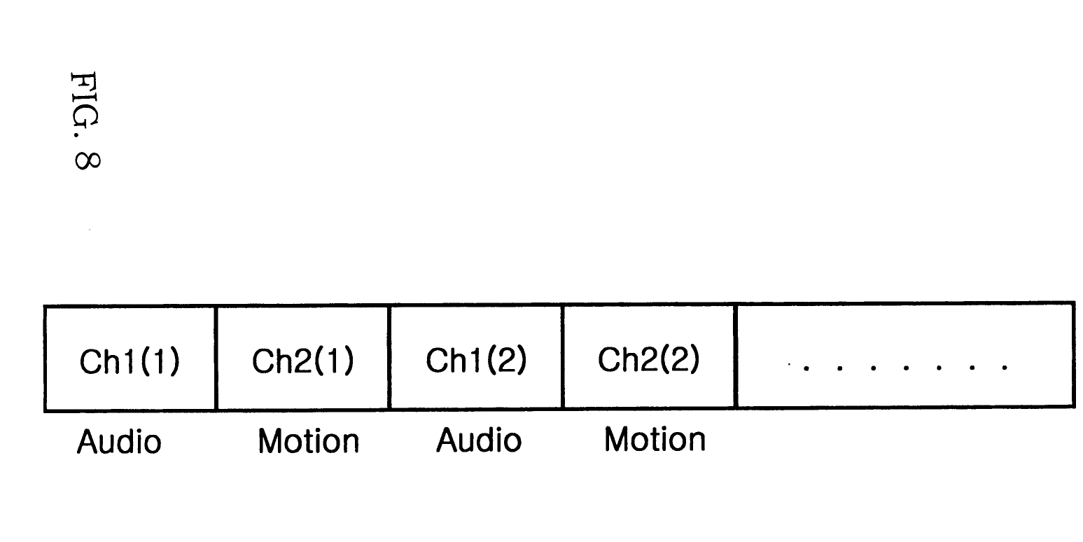

Finally, when the above process is repeated, the respective bits R15, . . . , and R0 of the register 27 are set to the respective bit values of the motion control data, that is, the bit values t0, . . . , and t7 of the register 27, as shown at the upper part of FIG. 8, and the respective bit values are represented as PWM pulses, as shown at the lower part of FIG. 8.

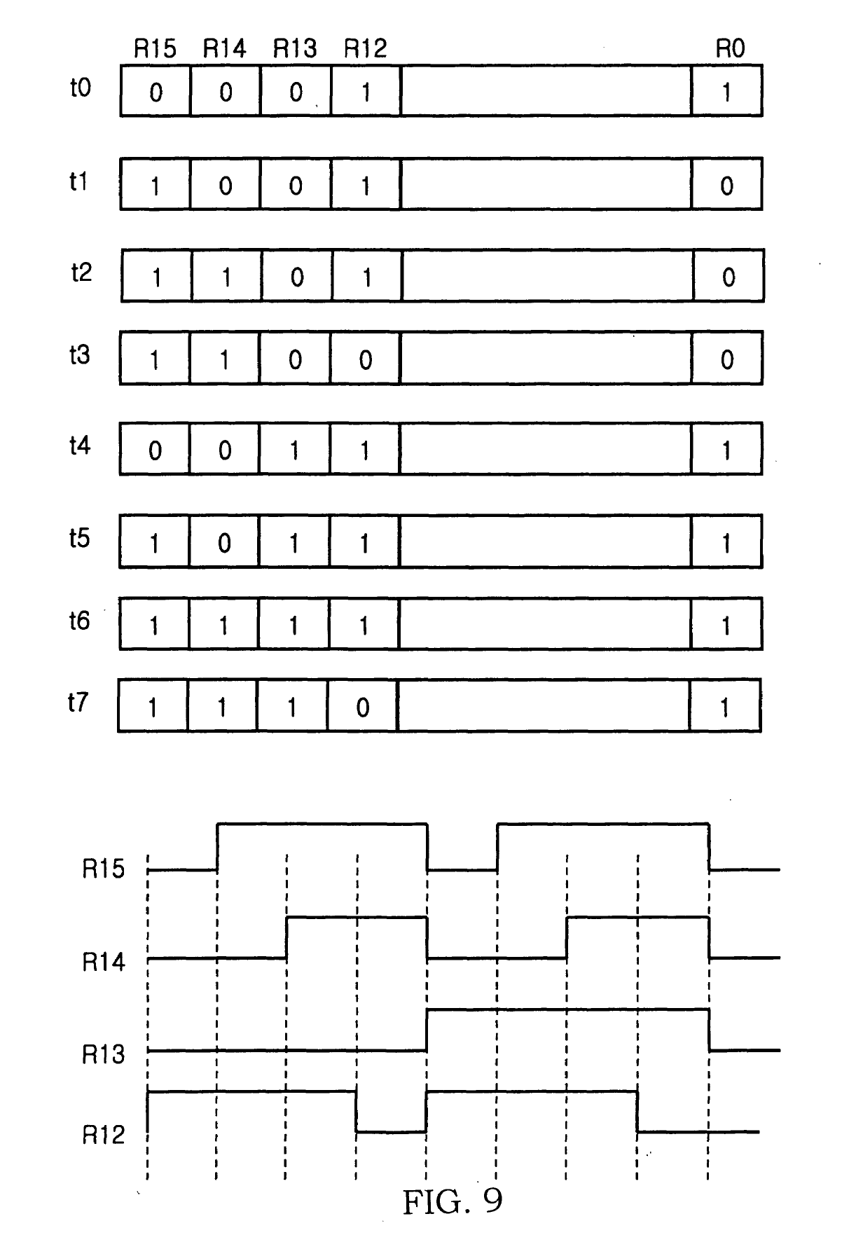

Each of the pulse motor driving circuits DR1, . . . , and DR4 is wired to receive only the necessary bit of the register 27, as shown in FIG. 5. When respective bits are assigned, as shown in FIG. 9 (which will be described in detail below), and pupil motion control data bits M8, M9, M10 and M11 are not used, neck joint motion control data bits M0, M1, M2 and M3 are input to the driving circuit DR1, a lip joint motion control data bit M12 is input to the driving circuit DR2, right arm joint motion control data bits M6 and M7 are input to the driving circuit DR3, and left arm joint motion control data bits M4 and M5 are input to the driving circuit DR4, as shown in FIG. 5, so that PWM pulse strings are input to the input terminals of the driving circuit DR1, . . . , and DR4, to which M0, . . . , M7, and M12 are input.

As a result, through the above-described process, when the robot terminal 23 of the present invention is connected to the PC 22, as shown in FIG. 5, and a WAVE file including motion control data is received by the PC 22, related motors or relays are automatically operated by the PWM driving circuits DR1, . . . , and DR4 while sound is automatically issued through the speaker via Ch1. Furthermore, when a typical audio WAVE file is received, stereo sound is issued through a typical USB audio device 28. Of course, external sound is input to the PC 22 through the microphone 31, the microphone amplifier 32 and the USB interface 24.

In the above case, a PWM signal is used to control velocity, brightness or force by directly controlling the amount of current applied to a motor, a Light-Emitting Diode (LED) or a solenoid, or is used by being sent to a location control servo module to control the angle of a joint when the PWM signal is information about the position of a joint.

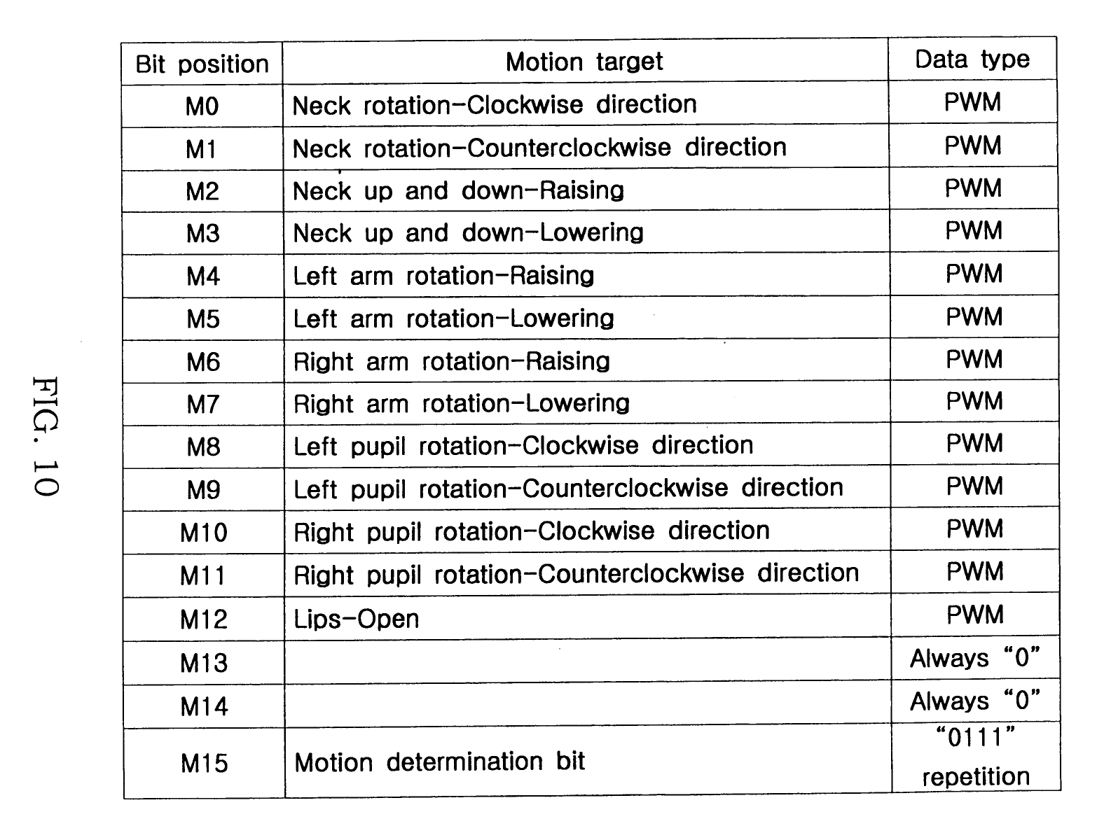

Next, the structure of motion control data M14, . . . , and M0 is described with reference to FIGS. 9 and 10 below.

The respective bits of the motion control data of FIG. 9, assigned to Ch2, are assigned to a clockwise direction, a counterclockwise direction, raising or lowering, available motions are limited to seven motions, that is, the rotation of the neck, the raising and lowering of the neck, the rotation of the left arm, the rotation of the right arm, the movement of the left pupil, the movement of the right pupil, and the movement of the lips. If two motion bits are assigned to a single motion target, for example, two bits M0 and M1 are respectively assigned to the clockwise rotation and counterclockwise rotation of the neck, this is not desirable from the aspect of efficiency.

In order to mitigate the above disadvantage, a method may be used in which, as shown in FIG. 10, each motion bit is assigned to a single motion target, a direction instruction bit is set as M14 so as to instruct the direction of movement of the motion target, the robot terminal 23 receives a number of pieces of 16-bit motion control data corresponding to the number of motion targets (in FIG. 10, a maximum of 14), it is determined that motion control data is included in the 14 pieces of 16-bit data if pieces of motion determination bit M15 have a predetermined 14-bit data pattern (for example, “0111 1010 0101 11”), and setting is made such that pieces of direction instruction bits M14 instruct a neck rotation direction M0, . . . , and a tail direction M11 according to the sequence thereof (for example, if the direction instruction bit M14 is “0”, this instructs a forward direction (a clockwise direction, right, or raising), while, if the direction instruction bit is “1”, this instructs a reverse direction (a counterclockwise direction, left, or lowering)). By doing so, it is possible to deal with a double number of motion targets (10 motion targets of FIG. 10 compared to seven motion targets of FIG. 9). As a result, if the direction instruction bits M14 have the data pattern “0101 0110 1100 01”, instructions are made, for example, in the sequence of the clockwise rotation of the neck, the lowering of the neck, the raising of the left arm, . . . .

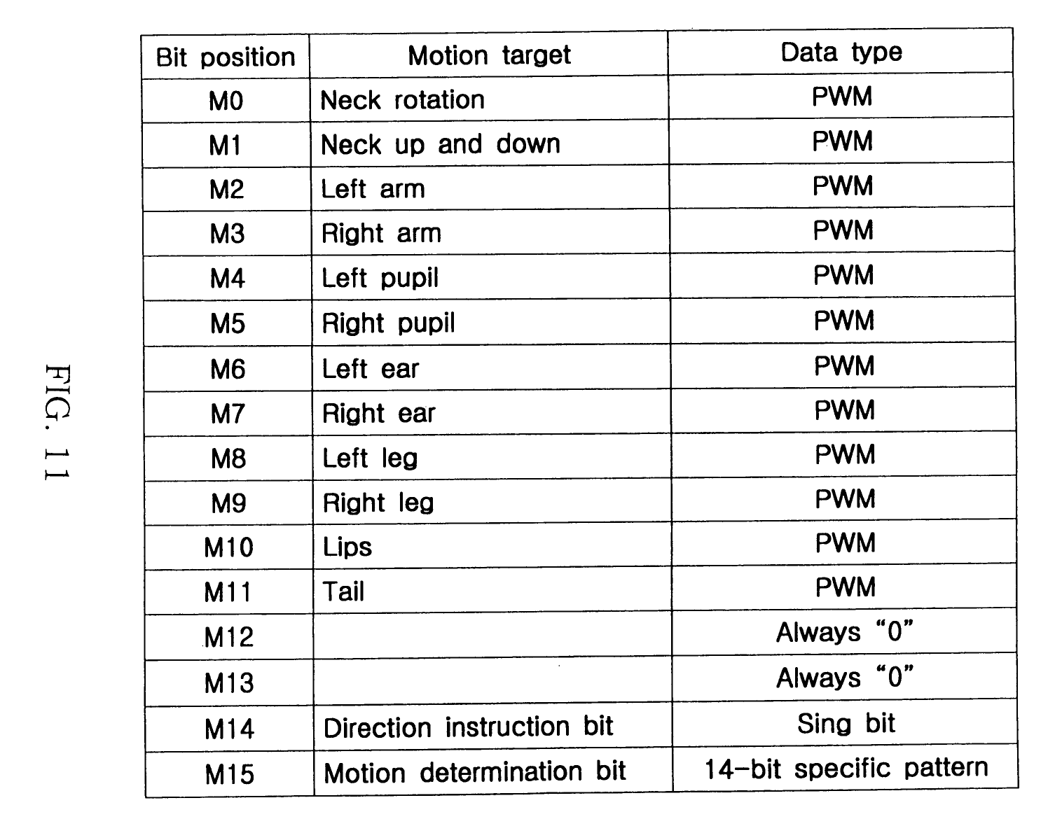

Meanwhile, in the case of a humanoid robot, or a robot terminal including a body part and a head part, it is not sufficient to provide 14 degrees of freedom using the method shown in FIG. 10 (a minimum of 20 degrees of freedom are required). In the case where more degrees of freedom are required, a total of 28 degrees of freedom can be ensured by assigning another channel. Alternatively, in order to increase the degrees of freedom in a more simple way, when a bit M13 is assigned to the transmission of serial data, as shown in FIG. 11, a maximum of 44,000 bps serial transmission data can be contained via the serial data transmission bit M13 in the case of 44 KHz sampling. Serial transmission data may contain more pieces of joint control information depending on the content thereof. In this case, 13 bits M0, . . . , and M12 are used as the motion control data.

Although the preferred embodiments of the present invention have been described above, the present invention is not limited to the embodiments, but it should be noted that various modifications are possible within a range that does not depart from the technical spirit of the present invention.

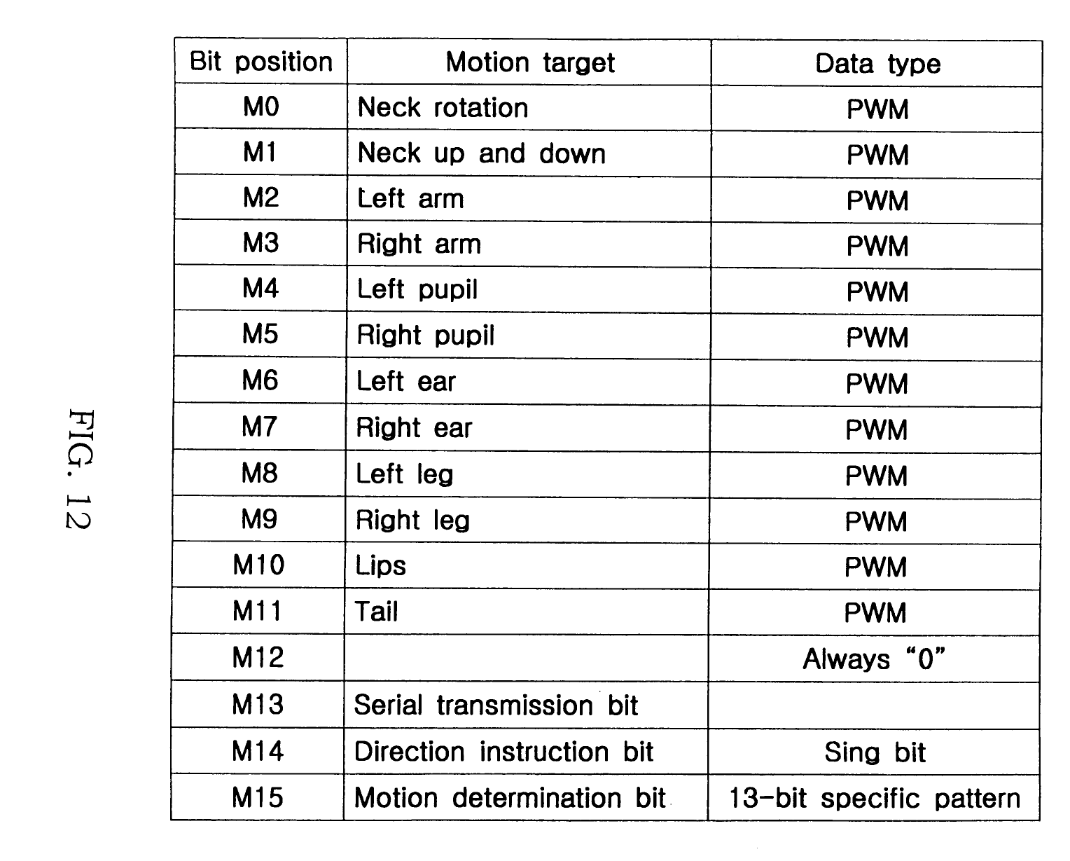

For example, although the method in which the PC 12 identifies motion control data and audio data has been used in FIG. 5, it is possible for the motion control data identification device 33 of the robot terminal 23 to identify motion data, as shown in FIG. 12. In this case, the PC 22 sends a WAVE file to the robot terminal 23 without determining whether motion control data is included, Ch1 data is sent to a left channel D/A converter 25 and Ch2 data is sent to the motion control data identification device 33, and the motion control data identification device 33 determines whether motion control data is included. If motion control data is not included, the motion control data is sent to PWM motor driving devices DR1, . . . , and DR4; if the motion control data is not included (that is, the WAVE file contains only typical audio data), typical audio data is discarded. Meanwhile, in this case, the PC 22 sends a WAVE file to the robot terminal 23 without determining whether the WAVE file contains motion control data, so that audio data is not sent to the typical USB audio device 28, like what is depicted in FIG. 12, with the result that audio is not played through the typical USB audio device 28.

In FIG. 5, the method was used in which the PC 22 determines whether motion control data is included in a WAVE file, and sends the WAVE file to the robot terminal 23 because the WAVE file is a WAVE file including motion control data if motion control data is included in the WAVE file, and sends the WAVE file to the typical USB audio device 28 because the WAVE file is a typical audio WAVE file if motion control data is not included in the WAVE file. However, in the case where the typical USB audio device 28 is not installed, a typical audio WAVE file must be sent to the robot terminal 23 so as to play audio, and the left channel D/A converter 25 and the speaker 26 must be utilized. In this case, audio data included in Ch2 is played through the motion control data register 27, therefore a related motor is overloaded and in danger of breaking down. Accordingly, in order to overcome this problem, it is preferable to basically install a motion control data identification device 33 in the robot terminal 23 regardless of whether a motion control data identification function is included in the PC 22, and to determine whether audio data is included in a WAVE file using the motion control data identification device 33, even if the audio file exists in the Ch2 of a WAVE file received by the robot terminal 23, and prevent the audio data from being played using a motor.

Although the method of using the 2 channels Ch1 and Ch2 of a WAVE file, and sending mono audio data via Ch1 and motion control data via Ch2 has been used, it is possible to extend the present invention, and to thus use the three channels Ch1, Ch2 and Ch3, and send stereo audio data via the Ch1 and Ch2 of a WAVE file and motion control data via Ch3. Furthermore, it is possible to use the four channels of a WAVE file, and to thus send stereo audio data via Ch1 and Ch2, motion control data via Ch3, and video data via Ch4.

Furthermore, if a method of using three channels as described above, playing audio data, sent via Ch1 and Ch2, using the stereo speaker of the robot terminal 23, sending motion control data to the PWM motor driving devices DR1, . . . , and DR4 via Ch3 is used, a robot terminal 23 capable of playing stereo audio and performing motion can be implemented.

Furthermore, in FIG. 5, generally, the typical audio device 28 is dedicated to sound, therefore the sound reproduction quality of the typical audio device 28 is higher than that of the robot terminal 23. Accordingly, it is possible to use a method of sending audio data (mono or stereo data) from the PC 22 to the typical audio device 28 and then playing the audio data using the typical audio device 28, and sending only motion control data to the robot terminal 23 and executing the motion control data through the robot terminal 23.

Meanwhile, although the robot terminal has been described as receiving a WAVE file via the PC, it is possible to receive a WAVE file via various means (for example, a mobile phone or a personal digital assistant) that can perform communication, such as Internet communication.

Furthermore, although the description has been made such that the PC 22 receives a WAVE file including motion control data from the service server 21 at a desired time and the WAVE file is played in the robot terminal 23, it is possible to directly play a WAVE file including motion control data stored in a PC and view motion, to generate robot motion through the real-time streaming service of the service server 21, or to create WAVE data including motion control data in conjunction with an event occurring during use of PC, for example, the movement of a joystick/mouse in real time, send the WAVE data to the robot terminal and generate corresponding motion (for example, winking motion, which is performed by the robot terminal at the time at which a mouse is clicked) in real time.

If the above-described service server 21 is a web application server and a WAVE file including motion control data is added to a web page, a unique web site, in which the robot terminal 23 performs a bowing motion while issuing utterance at the moment that the web page is displayed on the monitor of a user's computer, can be constructed.

When the above-described present invention is used, it is possible for a PC to receive multimedia data including motion control data for a robot terminal using a WAVE file, which is widely used in the case of transmitting a music file, and for an audio device-compatible robot terminal connected to the PC to play the multimedia data including motion data.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A motion control data transmission and motion playing method for an audio device-compatible robot terminal, comprising the steps of:
creating a multimedia file, including motion control data, in an audio transmission file format in such a manner that motion control data and data for determination of whether the motion control data is included are inserted into a specific channel and audio data is inserted into another specific channel;
sending the multimedia file, including the motion control data, to a terminal device using a transmission method suitable for the audio transmission file format;
the terminal device determining whether the motion control data is included based on the determination data included in the multimedia file, including the motion control data, and sending the motion control data to the robot terminal if the motion control data is included, and sending no motion control data if the motion control data is not included;
the robot terminal sending the received motion control data to a motion driving device; and
playing motion of the robot terminal through the motion driving device.

2. A motion control data transmission and motion playing method for an audio device-compatible robot terminal, comprising the steps of:
creating a multimedia file, including motion control data, in an audio transmission file format in such a manner that motion control data and data for determination of whether the motion control data is included are inserted into a specific channel and audio data is inserted into another specific channel;
sending the multimedia file, including the motion control data, to a terminal device using a transmission method suitable for the audio transmission file format;
the terminal device sending the motion control data and the determination data to the robot terminal;
the robot terminal determining whether the motion control data is included based on the determination data, and sending the motion control data to a motion driving device if the motion control data is included, and sending no motion control data if the motion control data is not included; and
playing motion of the robot terminal through the motion driving device.

3. The motion control data transmission and motion playing method for an audio device-compatible robot terminal as set forth in claim 1 or 2, wherein the terminal device audio is a Personal Computer (PC).

4. The motion control data transmission and motion playing method for an audio device-compatible robot terminal as set forth in claim 1 or 2, wherein the determination is performed by examining a repetition pattern of first specific bit of the determination data.

5. The motion control data transmission and motion playing method for an audio device-compatible robot terminal as set forth in claim 4, wherein a repetition pattern of second specific bit of the determination data determines one or more directions of the related motion joint if, as a result of the determination, the motion control data is included in the received determination data.

6. The motion control data transmission and motion playing method for an audio device-compatible robot terminal as set forth in claim 4, wherein serial transmission of third specific bit of the determination data forms additional motion control data if, as a result of the determination, the motion control data is included in the received determination data.

7. The motion control data transmission and motion playing method for an audio device-compatible robot terminal as set forth in claim 1 or 2, wherein the audio transmission file is a WAVE file.

8. The motion control data transmission and motion playing method for an audio device-compatible robot terminal as set forth in claim 1 or 2, wherein the motion control data forms one or more Pulse Width Modulation (PWM) pulse strings that control the motion driving device.

9. The motion control data transmission and motion playing method for an audio device-compatible robot terminal as set forth in claim 1 or 2, wherein each bit of the motion control data is assigned to a specific driving target.

10. The motion control data transmission and motion playing method for an audio device-compatible robot terminal as set forth in claim 1 or 2, wherein the motion is motion related to a web page that is viewed by a user.

11. The motion control data transmission and motion playing method for an audio device-compatible robot terminal as set forth in claim 1 or 2, wherein the motion is motion related to an event that occurs during use of a Personal Computer (PC).
